(19) United States
(12) Patent Application Publication
(10) Pub. No.: US 2014/0052992 A1
(43) Pub. Date: Feb. 20, 2014

(54) Response to Queries by Means of the Communication Terminal of a User

(71) Applicants: Thorsten Nozulak, Datteln (DE); Ulrich Seifert, Dusseldorf (DE); Cedric Rigal, Willich (DE)

(72) Inventors: Thorsten Nozulak, Datteln (DE); Ulrich Seifert, Dusseldorf (DE); Cedric Rigal, Willich (DE)

(73) Assignee: Vodafone Holding GmbH, Dusseldorf (DE)

(21) Appl. No.: 14/114,969

(22) PCT Filed: Apr. 25, 2012
(86) PCT No.: PCT/EP2012/057558

§ 371 Date: Oct. 31, 2013

(30) Foreign Application Priority Data
May 4, 2011 (DE) 10 2011 075 257.9

(51) Int. Cl. H04L 29/06

(52) U.S. Cl. CPC H04L 63/0428
USPC 713/171

(57) ABSTRACT

The subject innovation relates to a method with which a response to a request—said response having been ascertained by means of a communication terminal device can be securely transmitted to a data means, whereby the communication terminal device makes a selection from a plurality of response options. A specific key is associated with each of the response options, and the keys, which are in encrypted form, are received, together with the request, in the communication terminal device and they are decrypted in a means of the communication terminal device. On the basis of the selection made, the means ascertains the key that is associated with the selected response option, and the ascertained key is sent in a response message to the data means. The subject innovation also relates to a communication terminal device that is suitable for carrying out the method.

### CROSS-REFERENCE TO RELATED APPLICATIONS

Pursuant to 35 U.S.C. §371, this application is the United States National Stage Application of International Patent Application No. PCT/EP2012/057558, filed on Apr. 25, 2012, the contents of which are incorporated by reference as if set forth in their entirety herein, which claims priority to German (DE) Patent Application No. 10 2011 075 257.9, filed Apr. 5, 2011, the contents of which are incorporated by reference as if set forth in their entirety herein.

### BACKGROUND

Communication terminal devices, such as, mobile communication terminal devices, can be used to respond to automatic or user-controlled requests that are sent by a data means to the communication terminal devices.

For example, a request for the authorization of a specific electronic transaction, in which, for instance, a bank account or credit account and/or sensitive personal data of the user is accessed, can be sent to the communication terminal device, and displayed to the user by the communication terminal device together with available response options that can comprise an acceptance or a rejection. The user can choose from the response options by an operator input. Here, it can additionally be provided that an authentication feature of the user, for example, a personal identification number (PIN) is checked in order to ensure that the selection was made by the user himself or herself. The response of the user can be sent to the data means.

An example of such an authorization of a transaction using a mobile communication terminal device is described in European patent application EP 2 234 423 A1. In the method disclosed there, the provision of personal identification data of the user that is stored in a data means for a service is authorized by the user by his or her communication terminal device in the manner described above. In the described method, the authorization is controlled in the communication terminal device by an application that is installed and executed in a SIM (Subscriber Identity Module) or USIM (Universal Subscriber Identification Module) card of the device.

In order to avoid fraudulent use of a method of the type described above, there is a use for securing the communication between the data means and the communication terminal device. The security can be achieved in that the request is sent in encrypted form to the communication terminal device, and in that the communication terminal device sends the response to the request likewise in encrypted form.

When it comes to communication with a SIM card or a USIM card of the type used in GSM (Global System for Mobile Communications) or UMTS (Universal Mobile Telecommunications System) mobile telecommunication networks, such as, the so-called OTA (over the air) mechanism is available for the encryption. This is a mechanism for remote access to chip cards, which was specified by the ETSI (European Telecommunications Standard Institute) or by the 3GPP (3^{rd} Generation Partnership Project) in various versions in the standard documents GSM 03.48, TS 23.048 as well as TS 102 225, TS 102 226, TS 31.114 and TS 31.115 Implementations of the OTA mechanism normally provide that an OTA server sends to the chip cards information that has been encrypted with secret cryptographic keys (OTA keys) that are unambiguously associated with the identification modules and stored in a database of the OTA server. Thus, the request sent to the communication terminal device can be encrypted with the OTA key of the chip card that is on hand. It is likewise fundamentally conceivable for the response sent by the communication terminal device to be encrypted by means of the OTA key.

When the communication is encrypted, e.g., when the response that is sent by the communication terminal device is encrypted, however, the limited resources of the communication terminal device or of the chip card are burdened by the cryptographic operation associated with the encryption. This results in greater power consumption and thus, in the case of battery-powered operation, in a shorter operating time. Moreover, this can lead to delays in other tasks that are to be performed by the resources, which the user of the communication terminal device may find to be disturbing.

Regarding the OTA mechanism described above, there is the additional problem that, for security reasons, implementations of the mechanism permit the OTA key only to decrypt OTA messages received in the chip card, but they do not permit the encryption in the chip card of messages that are to be sent. With these implementations, the response cannot be secured by means of the OTA key or by means of the OTA message. In order to be able to use the OTA mechanism to secure the response sent by the communication terminal device, this security feature is relinquished. As an alternative, another encryption mechanism could be used. However, it would be additionally implemented in the communication terminal device or in the SIM card, and this is associated with quite a considerable effort. Moreover, this would use more storage space in order to store an additional key in the chip card for encrypting the response and any additional parameters or algorithms of the encryption mechanism.

For the above-mentioned reasons, it is desirable to allow a secure transmission of a response to a request, with which, irrespective of an encryption, a great level of security against manipulation of the response is achieved.

Before this backdrop, the subject innovation provides a method according to claim 1 and a communication terminal device according to claim 13. Embodiments of the method and of the communication terminal device are put forward in the dependent claims.

According to a first aspect, the subject innovation includes a method with which a response to a request, said response having been ascertained by means of a communication terminal device, can be securely transmitted to a data means, whereby a selection from a plurality of response options is made by the communication terminal device. A specific key is associated with each of the response options, and the keys, which are in encrypted form, are received and decrypted together with the request in the communication terminal device. On the basis of the selection made, a communication terminal device ascertains the key that is associated with the selected response option, and the ascertained key is sent in a response message to the data means.

According to another aspect of the subject innovation, a communication terminal device is proposed with which a response to a request can be selected from a plurality of response options. A key is associated with each of the response options and the communication terminal device is configured to receive the keys in encrypted form together with the request. A communication terminal device is configured to decrypt the keys and, on the basis of the selection made, to ascertain the key associated with the selected response option, and the communication terminal device is configured to send the ascertained key in a response message to the data means.

### SUMMARY

The subject innovation relates to responding to requests to the communication terminal device of a user. The subject innovation relates to a method with which a response to a request said response having been ascertained by a communication terminal device can be securely transmitted to a data means. The subject innovation also relates to a communication terminal device that is suitable for carrying out the method.

Moreover, a system is provided that comprises a communication terminal device of the type described here and that comprises the data means.

Without knowledge of the key associated with another response option, an attacker could not manipulate the selected response option to the request by the communication terminal device along the transport route and replace the response option. Because of the encrypted transmission of the specific key associated with the response options, however, an attacker is prevented from acquiring knowledge about the keys associated with the other responses. Moreover, a third party who reads out the key contained in the response message is prevented from deriving the given response without knowing the association between the response options and the keys. However, this association is protected against unauthorized access, such as that due to the encrypted transmission to the communication terminal device. Thus, surreptitious manipulations of the response message and an unauthorized reading-out of the response can be prevented. Hence, the key contained in the response message may not be secured against unauthorized access. It is possible to dispense with an encryption of the response message, that is to say, a high level of security is achieved, independently of the encryption.

Since the security is ensured independently of the encryption, the key that is associated with the selection that has been made can be transmitted in the response message to the data means without being encrypted. In this context, the term encryption refers to specific encryption, that is to say, an encryption that is carried out specifically for the response message at the application level. By dispensing with such encryption, computing capacity in the communication terminal device can be saved, as a result of which the power consumption can be lowered and, in the case of battery-powered operation, the operating time can be prolonged. Possible transport encryptions, which, irrespective of the type of messages and data transmitted, are performed as a standard feature along parts of the transport route are not considered to be encryptions in the above-mentioned sense of the word, and they can also be carried out in the embodiment described here. By the same token, however, encryption of the response message can be provided at the application level, for example, in order to comply with prescribed security guidelines.

One embodiment of the method and of the communication terminal device or of the system provides that the keys associated with the response options are supplied by the data means and are stored in the data means, at least until the response has been received. In another embodiment, it is provided that the data means ascertains the selection made on the basis of the key contained in the response message.

A refinement of the method and of the communication terminal device or of the system is characterized in that the keys that are associated with the response options have a random or pseudo-random relationship to each other. This means that an observer who acquires knowledge about the key that is associated with a response option cannot derive the keys that are associated with other response options. Moreover, one embodiment of the method and of the communication terminal device is characterized in that the keys associated with the response options are only used once, that is to say, the keys are only used for one request. Thus, these are so-called session keys. Both of the above-mentioned embodiments prevent an attacker who reads out the key contained in the response message replacing it with a valid key for a selection that is different from the one made by the communication terminal device.

In one embodiment of the method and of the communication terminal device, the security is further increased in that a period of validity is associated with the keys, and the response message is considered as being invalid if it is received in the data means after the end of the period of validity. The period of validity starts, for example, when the request is generated or when the request is transmitted to the communication terminal device. The period of validity is dimensioned so as to be sufficiently long for the request to be transmitted to the communication terminal device, for the request to be processed in the communication terminal device, and for the response message to be transmitted to the data means. The period of validity is able to rule out attacks that are based on the fact that, during a long available period of time that is used, for instance, for computation, a third party might gain access to protected information such as, for example, the association between the response options and the keys, and might then use this information to manipulate the response message.

The request to which the communication terminal device responds can be directed to the user of the communication terminal device. For this reason, one embodiment of the method and of the communication terminal device or of the system provides that the response options are presented to a user by an output device of the communication terminal device and/or that the selection of the response options is made through an input by the user on the communication terminal device. Moreover, one embodiment of the method and of the communication terminal device or of the system provides that the response message is only sent once the means has successfully verified an authentication feature entered by the user. This ensures that the selection is being made by the user himself or herself, and not by a third party who is in possession of the communication terminal device of the user. Furthermore, it is made possible that the request can also be made for purposes of authenticating the user. The authentication feature can be, for example, a PIN or a biometric characteristic of the user.

In one embodiment of the subject innovation, the communication terminal device is a terminal device that can be used in a mobile telecommunications network, and decrypting the keys associated with the response options and ascertaining the keys associated with the selected response option is performed by an identification module that can be used to identify and/or authenticate a subscriber in a mobile telecommunications network. An advantage of this embodiment is that the decryption of the keys associated with the response options takes place in the secured identification module whose security feature protects the keys against unauthorized access. The identification module can be configured as a chip. In one embodiment, the chip can be an integral part of a chip card that is inserted into the communication terminal device. This can be a SIM card or a USIM card. By the same token, however, it can also be that the identification module is configured as a software module that is implemented in a processor of the communication terminal device, whereby said processor is also in charge of performing other tasks. In particular, it can be a main processor of the communication terminal device.

Moreover, in one embodiment of the method and of the communication terminal device or of the system, it is provided that the request and the keys associated with the response options are sent to the communication terminal device in an OTA message, and that the OTA message is decrypted in the identification module. In order to securely transmit the request and the key associated with the response options, this embodiment advantageously makes use of the OTA mechanism already present so that no new mechanism is to be set up for an encrypted transmission of this information.

The OTA message is encrypted with a key that is associated with the identification module and that is securely stored in an OTA server. In order for the OTA message with the request and the key associated with the response options to be sent to the communication terminal device, one embodiment of the method and of the communication terminal device or of the system provides that the OTA message is sent by the OTA server in response to instructions transmitted from the data means to the OTA server. In this embodiment, the key that is stored in the OTA server and that is associated with the identification module in order to encrypt the OTA message advantageously may not leave the OTA server.

In one embodiment, the request is sent to the communication terminal device in response to a prompt from a computer device that interacts with the user, and the data means transmits the ascertained response to the computer device on the basis of the key received with the response. Here, the request can refer, for instance, to executing a transaction within the scope of a service provided by the computer device, and the above-mentioned response options can comprise an acceptance of the transaction or a rejection of the transaction.

### BRIEF DESCRIPTION OF THE DRAWINGS

The above-mentioned as well as other advantages, features and practical refinements of the subject innovation are also explained with reference to the embodiments that are described below with reference to the figures.

The figures show the following:

FIG. 1 is a schematic representation of a system in which communication takes place between a data means and a communication terminal device,

FIG. 2 is a schematic view of a request and associated response options as well as the keys associated with them, and

FIG. 3 is a schematic view of the handling of a request in the system shown in FIG. 1.

### DETAILED DESCRIPTION OF THE DRAWINGS

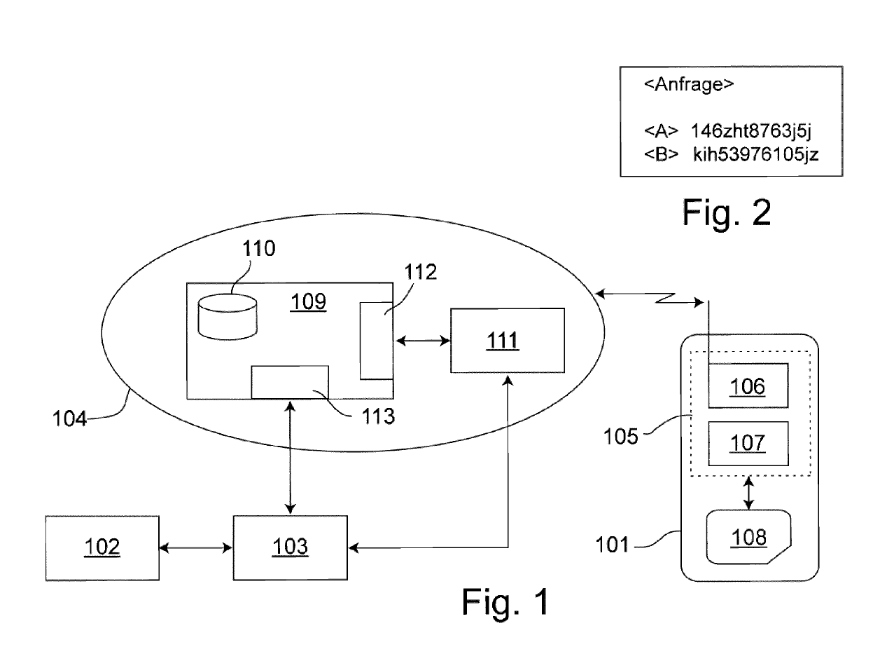

FIG. 1 schematically shows a system in which a communication terminal device 101 of a user can respond to requests that are made by a computer device 102. In the embodiment described below, the computer device interacts with the user of the communication terminal device 101 to whom the request is directed, and the user responds to this request by means of his or her communication terminal device 101.

The user can access the computer device 102 in various manners. For example, the user can interact directly with the computer device 102 by using appropriate input and output devices. Here, the request responded to by the communication terminal device 101 can be, for example, a request to enable functions of the computer device, whereby, on the basis of the response to the request, at the same time, the identity can be verified if the access authorization depends on the identity of the user. In another embodiment, the user accesses the computer device 102 by a suitable electronic device that can be the communication terminal device 101 as well as some other electronic communication device such as, for example, a personal computer (PC) or a similar computer device, via a data network such as, the Internet. In this case, the computer device 102 can be a server device that provides a service such as, a service for placing orders, a service for online banking or a social network service. Requests in conjunction with such services can be, for example, the authorization of transactions, such as payment procedures or access to sensitive personal data of the user.

The handling of the requests is controlled by a data means 103 that, in the embodiment shown in FIG. 1, is a distinct server device that is separate from the computer device 102. When a request is to be sent to the communication terminal device 101, the computer device 102 transmits instructions to this effect to the data means 103, and the response to the request received by the communication terminal device 101 is reported by the data means 103 to the computer device 102. The communication connection between the computer device 102 and the data means 103 can be established via a data network, whereby the communication is secured against unauthorized manipulations and against data eavesdropping. For this purpose, methods generally known to the person skilled in the art can be used such as, for example, suitable encryption mechanisms. The separation of the computer device 102 and the data means 103 is practical when a plurality of computer devices 102 access the data means 103 in order to have requests to communication terminal devices 102 carried out by the data means 103. The data means 103 and the various computer devices 102 that access the data means 103 can be operated by different service providers. In another embodiment, however, it can also be provided that the data means 103 is integrated into the computer device. This is advantageous when the data means 103 is exclusively provided for purposes of handling requests that are made by a single computer device 102.

In the embodiment shown, the communication terminal device 101 of the user is configured as a mobile communication terminal device 101 such as a mobile phone, a smartphone, a tablet or notebook computer or the like, which can connect wirelessly via an access network (not shown in the figure) to a mobile telecommunications network 104 in order to make use of mobile telecommunications services provided by the mobile telecommunications network 104 such as, for example, services for voice, data and message transmission. Examples of services that can be provided by the mobile telecommunications network 101 and that can be utilized by the mobile terminal device 102 include services for voice and/or video telephony, data services or services for access to data networks such as the Internet, as well as message services such as SMS or MMS (Multimedia Messaging Service) or e-mail.

In the embodiment as a mobile telecommunications-capable device, the communication terminal device 101 comprises a terminal 105 having a radio module 106 with which the communication terminal device 101 can connect to the mobile telecommunications network via the radio access network. For this purpose, the radio module 106 has useful radio technology, for example, an antenna with the appertaining peripherals, and it also has a control unit for controlling the radio module 106 and for performing the data processing for the data exchange with the mobile telecommunications network or with the radio access network. Aside from the radio module 106, the terminal 103 has a user interface 107 for interaction between the communication terminal device 101 and the user. The user interface 107 can also have a visual output device configured as a display as well as one or more input devices such as, a keyboard and/or a joystick. The display can also be configured as a touchscreen and can thus serve as a visual output device and also as an input device. Moreover, the user interface 107 can provide additional input and output devices, for instance, for the input and/or output of audio signals. In addition to the radio module 106 and to the user interface 107, the terminal 105 has additional components (not shown in the figure) such as, for example, one or more processors for controlling the terminal 105 and for executing additional programs used by the operator, one or more memory units for storing data and programs, and optionally, additional hardware and software components for executing the functions provided in the terminal 105.

The radio module 106 can be connected to an identification module 108 of the communication terminal device 101 that is implemented in the terminal and that provides data and processes for the communication terminal device 101 to access the mobile telecommunications network 104. Among other things, data and processes provided by the identification module 108 are used for subscriber identification and authentication in the mobile telecommunications network 104. The subscriber identification and authentication are normally carried out during the log-on to the mobile telecommunications network 104 and this comprises the identification of the identification module 108 on the basis of an identifier that is sent by the identification module 108 to the mobile telecommunications network 104 as well as the authentication of the identification module 108 on the basis of information that is computed in the identification module 108 using prescribed algorithms and information. The identification module 108 has a security architecture that prevents unauthorized access to data and processes, such as, to the above-mentioned data and processes used to access the mobile telecommunications network 104.

In one embodiment, the identification module 108 is a secured chip that is contained in a chip card that can be removably inserted into a card reader of the terminal 105. In this embodiment, the identification module 108 can be a SIM card or a USIM card that is used to access a mobile telecommunications network 101 and that can be configured as a GSM, UMTS or LTE (Long Term Evolution) network. By the same token, the identification module 108 can be a chip that is permanently integrated into the communication terminal device 101. The chip can also be configured as a SIM chip or a USIM chip. In another embodiment, the identification module 108 is a secured software module used on a processor of the communication terminal device 101 that is also employed for other tasks and that can be, for example, the main processor of the communication terminal device 101.

The identification module 108 is registered in a mobile telecommunications network 104, which is also referred to as the home network of the identification module 108 or of the user of the communication terminal device 101, and which is shown in FIG. 1. The home network 104 can be the mobile telecommunications network with whose operator the user has entered into a mobile telecommunications contract. The operator of the home network 104, or an agent acting on its behalf, issues the identification module 108 to the user after it has been preconfigured in a secure process. In this context, data that is prescribed by the operator of the home network 104 and that is used for the identification and authentication of the identification module 108, processes prescribed by the operator such as, for example, encryption algorithms used during the authentication, and other data prescribed by the operator are all installed in the identification module 108.

In one embodiment, after the identification module 108 has been issued, the identification modules 108 registered in the mobile telecommunications network 104 can be accessed by remote access in order for modifications to be carried out. For example, data and processes or programs can be changed, augmented or deleted in the identification module 108. By means of the remote access, such modifications can be made without the identification modules being modified at a service point of the mobile telecommunications provider, or of another service provider or without reissuing. For the remote access to an identification module 108, an OTA mechanism can be used in which an OTA server 109 sends a message to the identification module 108 in question, whereby said message can contain data for installation into the identification module 108 and/or commands for changing data or for executing processes and programs in the identification module 108. The OTA server 109 can be arranged in the mobile telecommunications network 104, and can be operated, for instance, by the appertaining mobile telecommunications provider, or else it can be operated by a reliable organization outside of the mobile telecommunications network 104.

Cryptographic mechanisms are used in order to secure the remote access to the identification modules 108 and, in order to protect against unauthorized access to the identification modules 108. The messages sent by the OTA server 109 to an identification module 108, referred to below as OTA messages, are encrypted with a cryptographic key in order to protect them from unauthorized manipulation along the transport route as well as in order to prevent unauthorized parties from being able to send OTA messages to an identification module 108. The key is unambiguously associated with the appertaining identification module 108 and stored under an identifier of the identification module 108 in a database 110 of the OTA server 109. Received OTA messages are decrypted with the appropriate cryptographic key in the identification module 108. Along with the decryption, the authenticity of the messages is also verified, since the message is prevented from being successfully decrypted if it was encrypted with the correct key that is only stored in the OTA server 109.

The key used in the OTA server 109 for the encryption and the key used in the identification module 108 for the decryption, which are also referred to below as OTA keys, can form a symmetrical key pair. By the same token, however, the use of asymmetrical key pairs can also be provided for. The OTA key used in the identification module 108 can have been stored in the identification module 108 during its above-mentioned preconfiguration. The identifier under which the cryptographic keys associated with the identification modules 108 are stored in the database 110 of the OTA server 109 can be a phone number configured as an MSISDN and associated with the identification module 108, whereby said number can also be used to address the OTA messages to the identification module 108. In addition or as an alternative, the identifier can also comprise other identification codes associated with the identification module. If the phone number is not contained in the identifier, the phone number is stored in the OTA server 109, and used by the OTA server 109 to address messages to the identification module 108. As an alternative, the phone number is transferred to the OTA server 109 if the latter is instructed to send an OTA message to an identification module 108.

The OTA messages are transmitted via a data transmission service provided in the mobile telecommunications network 104. A short message service can be used which, in one embodiment, is the generally known SMS (Short Message Service). In the case of an SMS, short messages are sent by an SMSC (Short Message Service Center) 111 of the mobile telecommunications network 104 to the communication terminal devices 104 that are connected to the mobile telecommunications network 104. Therefore, for purposes of transmitting OTA messages, the OTA server 109 has an SMS interface 112 via which it is connected to the SMSC 111. In order to transmit an OTA message to an identification module 108, the OTA server 109 transfers the encrypted content of the OTA message together with the phone number associated with the identification module 108 to the SMSC 111 via the SMS interface 112. Making use of the phone number associated with the identification module 108, the SMSC 111 then sends an OTA message configured as an SMS message to the communication terminal device 101 in question. This is done in the same manner as the transmission of other SMS messages to the communication terminal device 101. However, the OTA message is forwarded by the terminal 105 to the identification module 108 on the basis of a identifier that it contains. This may be done transparently, to the user of the communication terminal device 101. In the identification module 108, the message is first decrypted after being received and, as described above, it is authenticated in this process. After the successful decryption, the message is evaluated and control commands contained in it are carried out.

Requests that are generated in the system shown in FIG. 1 by the computer device 102 and sent by the data means 103 to the communication terminal device 101 are processed in the communication terminal device 101 by a software application that, in one embodiment, is stored and executed in the identification module 108 of the communication terminal device. In this manner, the application is protected by the security mechanisms of the identification module 108 against unauthorized access. The application can be installed before the identification module 108 is issued, already during the above-mentioned preconfiguration in the identification module 108. By the same token, a subsequent installation is likewise possible, which can be done, for example, via remote access by means of the OTA mechanism.

The requests generated in the data means 103 are transmitted in encrypted messages to the identification module 108, e.g., in order to prevent the keys that are contained in the messages and that are associated with possible responses to the requests from being read out along the transport route. In the embodiment of the system shown in FIG. 1, the above-mentioned OTA mechanism is used for the encrypted transmission of the messages with the requests. In this manner, a mechanism that is already implemented in identification modules 108 as a standard feature can be used for a secure transmission of the messages with the requests. No new security mechanism is to be set up in the identification modules 108 for this purpose.

Therefore, in the manner described above, a request is sent from the OTA server 109 to an identification module 108 in an OTA message. For this purpose, the request from the data means 103 is first transferred to the OTA server 109 via an appropriate interface 113 thereof. The communication between the OTA server 109 and the data means 103 via the interface 113 is secured against unauthorized manipulation of data and against eavesdropping along the transport route. This can be done by measures that are familiar to the person skilled in the art. In addition to the content of the request, the data means 103 provides the OTA server 109 with the identifier of the identification module 108 to which the request is to be sent.

In one embodiment, the identifier is transferred from the computer device 102 to the data means 103 and this identifier can be indicated by the user of the communication terminal device 101 within the scope of the interaction with the computer device 102. As an alternative, another identifier associated with the user can be transferred from the computer device 102 to the data means 103 and, on the basis of this identifier, the data means 103 can ascertain the identifier of the identification module 108 issued to the user. For this purpose, the data means 103 can access a database in which associations between user identifiers and identifiers of associated identification modules are stored for a plurality of users.

Once the content of the request has been received and once the identifier of the appertaining identification module 108 has been received or ascertained, the OTA server 109 ascertains the OTA key of the identification module 108 that is stored in the database 110 and it generates an OTA message that is encrypted with this key. The OTA message is transferred to the SMSC 111 in the above-mentioned manner, and from the SMSC 111, the OTA message is sent to the communication terminal device 101 and forwarded to the identification module 108 within the communication terminal device 101.

In the identification module 108, on the basis of an identifier contained in the message, it is recognized that this is a request that is to be processed. In response to this, the previously described application of the identification module 108 that has been provided to process the requests is started. This application accesses the user interface 107 of the terminal 105 and presents the content of the request as well as the prescribed response options which will be discussed in greater detail below to the visual output device of the user interface 107. Moreover, the application receives the operator inputs of the user which are representative of the response to the request or representative of the selection from among the prescribed response options, which are then carried out on the basis of the presentation of the request and the response options by the user of the communication terminal device 101 employing input device of the user interface 107.

The options for responding to the request are prescribed by the computer device 102 together with the request, and they are already contained in the message sent to the identification module 108 along with the request. The application provided for processing the request causes the visual output device of the user interface 107 to present the response options in a suitable presentation form, for example, in a list, so that the user can select the desired response option by entering an appropriate operator input. The response selected by the user is reported in a response message to the data means 103. The response message is generated in the identification module 108 by the application that is provided for processing the request and it is then transferred to the terminal 105 for transmission to the data means 103.

The terminal 105 then transmits the response message to the data means 103. Any transmission methods can be used for this purpose. In one embodiment, the transmission is carried out via the mobile telecommunications network 104 by a message service provided by the mobile telecommunications network 104. This can, once again, be the SMS that can also be used to transmit the OTA messages to the communication terminal device 101. When the SMS is used, the response message is sent as an SMS message from the communication terminal device 101 or from the terminal 105 to the SMSC 111. The latter then forwards the response message to the data means 103. For this purpose, a connection between the SMSC 111 and the data means 103 can be used that can be established, for example, via the same data network as the connection between the data means 103 and the OTA server.

In order to access the user interface 107 as well as in order to control the transmission of the response message from the communication terminal device 101 to the data means 103, the application can make use of so-called proactive Card Application Toolkit (CAT) commands generally known to the person skilled in the art that allow a chip card to access functions of the terminal 105 under its own initiative. If the identification module 108 is configured as a SIM chip or a USIM chip, such as, commands of the SIM Application Toolkit (SAT) or USIM Application Toolkit (USAT) can be employed.

In order to ensure that the only operator inputs for selecting a response to the request that are taken into consideration are those from the user of the communication terminal device 101 himself or herself and not inputs that have been made by a third party, in one embodiment, an authentication feature of the user is verified before the application generates the response message to the request and transfers it to the terminal for transmission to the data means 103. The authentication feature can be, for example, a PIN that the user enters on the communication terminal device 101 when prompted to do so by an input device present in the user interface 107. By the same token, using input device of the user interface 107, other authentication features can be entered such as, for example, biometric characteristics of the user. In order to verify the authentication feature entered on the communication terminal device 101, the user interface 107 transfers this authentication feature to the identification module 108, where it is compared to a reference feature that has been stored in the identification module 108. This can have already been stored in the identification module 108 at the time of the preconfiguration, or else it can be stored at a later point in time by the user in the identification module 108 in a secure process.

After a successful verification of the authentication feature, that is to say, after there is a sufficient correspondence between the entered authentication feature and the reference feature, the application of the identification module generates the response message that is then transmitted to the data means 103. If the identification feature if applicable, after a prescribed number of repeated inputs at the user interface is not successfully verified, then the response message is not generated. Instead, an error routine can be executed that can, for instance, lock the application or the identification module 108 and/or a message being sent to the data means 103. As already indicated above, on the basis of the verification of the authentication feature, the identity of the user of the communication terminal device can be verified, so as to ensure that the response was given by the user. As mentioned, in this manner, requests can be effectuated not only in order to permit the selection of a response by the communication terminal device 101 but, at the same time, also for purposes of user authentication, which is carried out, for example, when the computer device 102 enables access to functions, services and/or data.

In one embodiment, the verification of the authentication feature is carried out at the time of the startup of the application that is provided for processing the request, whereby, as described above, this takes place in response to receiving the OTA message containing the request. In this embodiment, the application only processes the request further if the authentication feature has been successfully verified. Otherwise, the processing is aborted so that the presentation of the request is likewise not carried out in case of a failure of the verification of the identification feature. It can be additionally provided that a failure of the verification of the authentication feature is reported to the data means 103. By the same token, however, it can also be provided that the verification of the identification feature is carried out at a different point in time. For example, it can be provided that the user enters the identification feature together with the selection of the response to the request.

The response message generated by the application is not encrypted with the OTA key of the identification module 108. In one embodiment, the response message is transmitted in its entirety without a specific encryption, that is to say, without an encryption that is carried out specifically for the response message at the application level (transport encryption that is carried out as a standard feature, for example, for the transmission to the mobile telecommunications network 104 via the air interface is also carried out for the response message). Dispensing with the specific encryption has the advantage that cryptographic operations may not be considered when generating the response message. Furthermore, the response message can be generated even if the envisaged implementation of the OTA mechanism in the identification module 108 provides that the OTA key can be used only to decrypt received OTA messages and not to carry out encryptions in the identification module 108.

In an alternative embodiment, however, the encryption of the response message is not dispensed with entirely, but rather, the encryption is carried out independently of the OTA mechanism and not with the OTA key of the identification module 108, so that the response message can be encrypted, even when the OTA key cannot be used for this purpose. Through an encryption of the response message, it is possible, for example, to comply with prescribed security guidelines about encryption. However, the response message may be secured against surreptitious manipulations without using encryption.

Securing the response message against unauthorized manipulations and/or unauthorized reading-out along the transport route is achieved in that different keys are associated with the prescribed response options to the request, and only the key of the selected response is incorporated into the response message. The keys are associated with the response options in a secure manner in the data means 103 and, together with the request and the response options, they are transmitted in encrypted form to the identification module 108, where they are likewise secured against unauthorized access. This prevents unauthorized third parties from acquiring knowledge about the association between the response options and the associated keys. For this reason, no provision is made for a display of the keys on the user interface 107 of the communication terminal device 101.

The keys are generated by the data means 103 in such a way that a random or pseudo-random relationship exists between them, that is to say, an observer who acquires knowledge about one of the keys cannot derive the other keys. In this manner, a third party who accesses the response message and reads out the unprotected key for the selected response option is prevented from deriving the key associated with another response option and from systematically manipulating the key contained in the response message in such a way that said key matches the key of a communication terminal device that is different from the one selected by the user of the communication terminal device 101. Moreover, the keys may be used only once, that is to say, for one request. Thus, these are so-called session keys. In this manner, it is prevented that a key that has been read out of the response message by an attacker can be incorporated with fraudulent intent into another response message as a valid key.

In one embodiment, the keys are configured as alphanumeric character strings that are long enough to rule out manipulations with sufficient probability. In order to rule out a reproducible relationship between the keys for various response options, the character strings can be generated in the data means 103 by a random or pseudo-random algorithm. An example of a request with two response options A and B, which can stand, for example, for an acceptance and a rejection of a certain transaction indicated in the request, as well as the associated keys, are shown schematically in FIG. 2. The response option A here is associated with the key 146zht8763j5j, while the response option B is associated with the key kih53976105jz. The content of the request (<request>) as well as the response options A and B, as described above, can be displayed on the visual output device of the user interface 107 of the communication terminal device 101 in order to give the user the possibility to select a response option to the request. The keys may not be displayed.

In the data means 103, the generated keys remain associated with the provided response options after the request has been transmitted or transferred to the OTA server 109. When the data means 103 receives the response message that has been generated in the identification module 108 of the communication terminal device 101, it accesses the stored keys and ascertains the response that is associated with the key contained in the response message. This response is provided by the data means 103 to the computer device 102 as the response to the submitted request, and the computer device 103 proceeds as a function of the selected response option. Here, it can also be provided that the data means 103 also associates the response message with the previously transmitted request on the basis of the contained key, that is to say, said data means 103 ascertains the request to which the response applies, likewise on the basis of the key. In this manner, the response can be associated with the appertaining request on the basis of the key in the data means 103, and the response can be reported to the server 102 in association with the appertaining request.

Another security mechanism used in one embodiment in order to protect the response message against unauthorized manipulations provides that the keys are associated with a period of validity in the data means 103. The period of validity may be stored as a prescribed parameter in the data means 103. On the one hand, it is dimensioned so as to be sufficiently long for the request to be transmitted to the communication terminal device 101, for the request to be processed in the communication terminal device 101, and for the response message to be transmitted from the communication terminal device 101 to the data means 103. On the other hand, the period of validity is selected so as not to be too long. When the response message is received in the data means 103, then the data means verifies whether the period of validity of the contained key has expired or not. For this purpose, in one embodiment, when the data means generates the request or sends the response message, it creates a time stamp that is stored in the data means 103 in conjunction with the keys contained in the request. In the previously described embodiment, the sending of the response message corresponds to the transfer of the response message to the OTA server 109. When the response message is received, the data means 103 compares the time of receipt to the time stamp in order to check whether the response message was received within the period of validity. If this is the case, the response message is further processed. The received response is reported to the computer device 102. In contrast, if it is ascertained that the period of validity has expired, then the response is considered as being invalid and an error routine is started. Here, for example, an error can be reported to the computer device 102.

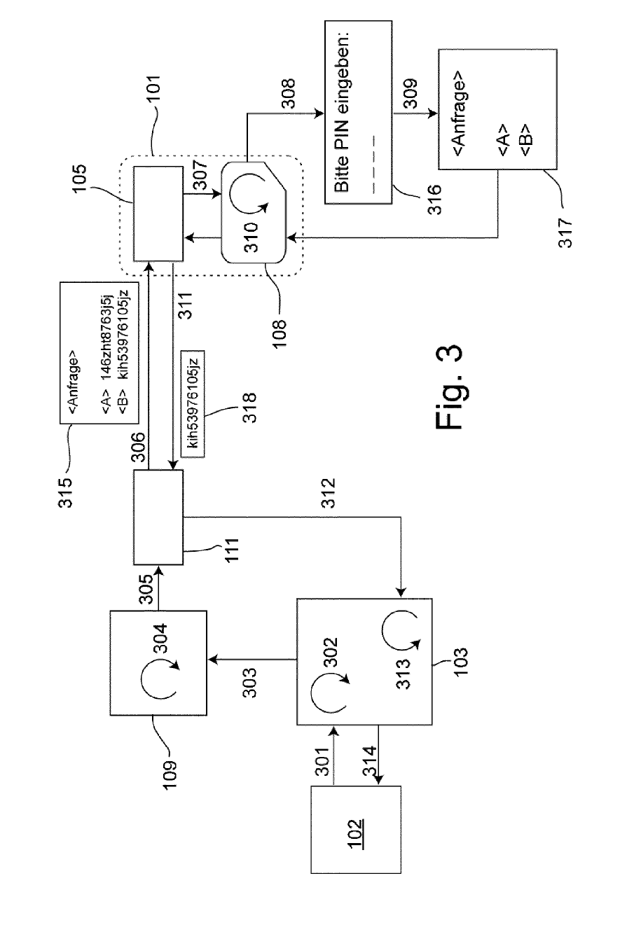

Using the above-mentioned mechanisms and means, in one embodiment given by way of an example, requests can be sent to the communication terminal device 101 and responded to by the communication terminal device 101, as will be shown below with reference to the schematic diagram of FIG. 3, in which various steps for handling a request are depicted. By way of an example, in FIG. 3, the request schematically depicted in FIG. 2 having two response options A and B is assumed.

First of all, a prompt to carry out a request is sent in Step 301 from the computer device 102 to the data means 103. The request can pertain, for example, to a transaction that is limited to being executed within the scope of a service utilized by the user of the communication terminal device 101 and that expects an acceptance or a rejection of the transaction. In Step 301, the content of the request, which can, for instance, describe the transaction that is to be executed, as well as prescribed response options, are transferred from the server 102 to the data means 103. In addition, the identifier of the identification module 108 used by the user in the communication terminal device 101 is transferred, or else another identifier of the user that the data means 103 associates in the above-mentioned manner with the identifier of the identification module 108 issued to the user is transferred.

After the request from the server 102 has been received, in Step 302, the data means generates a session key for each response option prescribed by the computer device 102. The session keys are generated in the above-mentioned manner in such a way that they have a random or pseudo-random relationship to each other. Then the data means 103 generates a response message containing the content transmitted from the computer device 103 as well as the associated session key. The response options as well as the associated session keys are also stored in the data means 103. In one embodiment, in conjunction with the session keys, a time stamp is also stored in the data means 103, which can pertain to the time when the response message is generated or else to the time when the response message is sent. In the embodiment described here, the latter corresponds to the subsequent transfer to the OTA server 109.

The request is sent in encrypted form to the communication terminal device 101 of the user, and the communication terminal device is recognized on the basis of the identifier associated with the identification module 108. In the embodiment shown in FIG. 3, for this purpose, the request is transferred to the OTA server 109 together with the identifier of the identification module 108. On the basis of the identifier, the OTA server 109 first ascertains the OTA key of the identification module 108 that is stored in the database 110 (see FIG. 1), and then, in Step 304, it generates an OTA message that contains the response message received by the data means 103 and that is encrypted with the OTA key of the identification module 108. The OTA message is then transmitted to the communication terminal device 101. In the embodiments shown in FIG. 3 and described above, this is done by SMS in that, in Step 305, the OTA message is first transferred to the SMSC 111 and then, in Step 306, sent to the communication terminal device 101. The content of the OTA message that corresponds to FIG. 2 and that contains the request as well as the response options and the associated keys are schematically depicted in FIG. 3 and designated with the reference numeral 315.

In the communication terminal device 101, in Step 307, the message is transferred to the identification module 108, which decrypts the OTA message with the OTA key stored in the identification module 108 and, after the decryption, further processes it. Here, the identification module 108 recognizes the request and starts the application for processing the request and for generating a response message. In Step 308, the application prompts the user of the communication terminal device 101 to enter the authentication feature that is linked to responding to requests. The prompt which, in FIG. 3 is shown in conjunction with an authentication feature configured as a PIN and designated with the reference numeral 316, is displayed on the user interface 107 of the communication terminal device 101 where the user also enters the authentication feature.

After the authentication feature has been entered, it is verified by the application and, once it has been successfully verified, the user is presented with the content of the request as well as with the response options on the visual output device of the user interface 107 of the communication terminal device 101. The application acquires the content of the request as well as the response options from the received OTA message. A presentation given by way of an example for the request shown in FIG. 2 and for the associated response options is shown schematically in FIG. 3 and designated with the reference numeral 317. From among the displayed response options, the user uses an input device of the user interface 107 of the communication terminal device 101 to select a response option, which is then registered in the application. The application then ascertains the session key that is associated with the selected response and that was received in the OTA message, and, in Step 310, generates a response message to the data means 103 containing the previously ascertained session key that is associated with the selected response. In this case, in the context of FIG. 3, it is assumed by way of an example that the user has selected the response option B, so that the response message contains the associated key kih53976105jz.

The response message is transferred from the identification module 108 to the terminal 105 of the communication terminal device 101 and then transmitted by the communication terminal device 101 to the data means 103. In the embodiment shown in FIG. 3, this is done by means of SMS in that the response message, as described above, is first sent to the SMSC 111 as an SMS message in Step 311, after which the SMSC 111 then transfers it to the data means 103 in Step 312. The content containing the key that is associated with the selected response option is illustrated schematically in FIG. 3 and designated with the reference numeral 318.

The data means 103 access the received response message and reads out the key that is contained in said response message and that is associated with the selected response, and then on the basis of the key from the previously stored association between the prescribed response options and the associated keys it ascertains the response option that has been selected by the user. Moreover, in one embodiment, the point in time when the response message was received is compared to the time stamp stored for the key in order to additionally verify whether the response message was received within the period of validity of the contained key. After the selected response has been ascertained and, if applicable, after the successful verification to check whether the response message was received within the period of validity, in Step 314, the response of the user is reported by the data means 103 to the computer devices 102. The computer device 102 then executes the transaction as a function of the received response or else it refrains from executing the transaction, if this was rejected by the response.

Although the subject innovation has been described in detail in the drawings and in the presentation given above, the presentations are merely illustrative and provided by way of an example, and should not be construed in a limiting manner. The subject innovation is not limited to the embodiments explained.

The subject innovation is not limited to processing requests that are generated by a service that is effectuated or controlled by the user. By the same token, the service can also be performed automatically without control by the user. Likewise, the response may not be selected by the user through an operating action undertaken by means of the user interface 107, but rather, the response to the request for the service can also be ascertained automatically in the communication terminal device 101.

Moreover, the subject innovation is not limited to specific requests. Rather, any kind of request can be sent for which several response options are prescribed, each of which is associated with a key. The response options can have any desired content. Moreover, there is fundamentally no limitation to a certain number of prescribed response options.

Moreover, there is no restriction to mobile communication terminal devices 101 or to communication terminal devices 101 that can be used in a mobile telecommunications network 104, but rather, the subject innovation can be used in a similar manner with any desired communication terminal devices 101 that are capable of communicating with a data means 103.

The person skilled in the art can glean additional variants of the subject innovation and their execution from the preceding disclosure, from the figures and from the patent claims.

In the patent claims, terms such as “encompass”, “comprise”, “contain”, “have” and the like do not exclude additional elements or steps. The use of the indefinite article does not preclude the plural. Each individual device can execute the functions of several of the units or devices cited in the patent claims. The reference numerals indicated in the patent claims are not to be construed as a limitation of the means and steps employed.

1-14. (canceled)

15. A method with which a response to a request, said response having been ascertained by means of a communication terminal device, can be securely transmitted to a data means, whereby the response is selected from a plurality of response options by means of the communication terminal device, whereby a key is associated with each of the response options, and the keys being in encrypted form, are received together with the request in the communication terminal device, and are decrypted in a means of the communication terminal device, and on the basis of the selected response option, the means ascertains the key that is associated with the selected response option, and the ascertained key is sent in a response message to the data means.

16. The method according to claim 15, the keys associated with the response options are supplied by the data means and are stored in the data means, at least until the response has been received.

17. The method according to claim 15, the data means ascertaining the selection made based on the key contained in the response message.

18. The method according to claim 15, the keys associated with the response options having a random or pseudo-random relationship to each other.

19. The method according to claim 15, each of the keys associated with the response option being limited to one use.

20. The method according to claim 15, a period of validity being associated with the keys, and the response message being invalid if it is received in the data means after an end of the period of validity.

21. The method according to claim 15, the response options being presented to a user by an output device of the communication terminal device and/or the selected response option being selected by means of an input by the user on the communication terminal device.

22. The method according to claim 15, the response message being only sent after the means successfully verifies an authentication feature entered by the user.

23. The method according to one claim 15, the communication terminal device being a device that can be used in a mobile telecommunications network, and means of the communication terminal device comprises an identification module that can be used to identify and/or authenticate a subscriber in a mobile telecommunications network.

24. The method according to claim 15, the request and the keys associated with the response options being sent to the communication terminal device in an over-the-air (OTA) message, and the OTA message is decrypted in the identification module.

25. The method according to claim 24, the OTA message is sent by an OTA server in response to instructions transmitted from the data means to the OTA server.

26. The method according to claim 25, the request being sent to the communication terminal device in response to a prompt from a computer device that interacts with the user, and the data means transmits the ascertained response to the computer device based on the key received with the response message.

27. A communication terminal device with which a response to a request can be selected from a plurality of response options, a key being associated with each of a plurality of response options, the communication terminal device configured to receive the keys in encrypted form together with the request in the communication terminal device, and a means of the communication terminal device configured to decrypt the keys and, based on a selected response option, to ascertain a key associated with the selected response option, and the communication terminal device configured to send the ascertained key in a response message to a data means.

28. A system comprising a communication terminal device with which a response to a request can be selected from a plurality of response options, a key being associated with each of the response options and the communication terminal device being configured to receive the keys in encrypted form together with the request in the communication terminal device, and whereby a means of the communication terminal device is configured to decrypt the keys and, on the basis of a selection made, to ascertain the key associated with the selected response option, and whereby the communication terminal device is configured to send the ascertained key in a response message to a data means, the data means being configured to provide the keys associated with the response options and to ascertain selected response options made based on the key contained in the response message.
